(19) United States
(12) Patent Application Publication
(10) Pub. No.: US 2007/0013751 A1
(43) Pub. Date: Jan. 18, 2007

(54) Image forming apparatus capable of displaying a message depending on the situation

(75) Inventor: Akihito Maemura, Ise-shi (JP)

Correspondence Address: DITTHAVONG & MORI, P.C., 10507 BRADDOCK ROAD, SUITE A, FAIRFAX, VA, 22032, US

(73) Assignee: KYOCERA MITA CORPORATION, Osaka-city (JP)

(21) Appl. No.: 11/486,781

(22) Filed: Jul. 14, 2006

(30) Foreign Application Priority Data
Jul. 14, 2005 (JP) 2005-206006

(51) Int. Cl. B41J 2/17

(52) U.S. Cl. 347/84; 347/86

(57) ABSTRACT

Upon message information is input by an information writer, the message information is wirelessly or optically transmitted to a write unit built in a toner cartridge and written in memory by the write unit, thereby allowing the message information to be rewriteable without change of software. A control unit reads out a display message corresponding to display timing from the memory to display the display message on a display unit.

### BACKGROUND OF THE INVENTION

1. Field of the Invention

This invention relates to a consumable storage container and an image forming apparatus with the consumable storage container inserted therein, and for example to a consumable storage container holding consumables such as toner used in electrophotography and an image forming apparatus, such as a printer, copying machine and FAX machine, containing the consumable storage container.

2. Description of Background Art

In order to keep track of consumables including toner, recording paper and so forth, some conventional image forming apparatuses use a consumable storage container, such as a toner cartridge and paper cassette, having memory built therein. Such an image forming apparatus allows the memory to have a region functioning as a counter that measures and displays usage of the toner and recording paper. Some may display the original manufacturer in the form of a manufacture code.

Another example disclosed in Japanese unexamined patent publication No. 2001-217978 is an image forming apparatus with an advertisement display function in which advertising information regarding the image forming apparatus is read out from an image memory provided in the image forming apparatus depending on a state of use of the toner and recording paper, and the read advertising information is displayed on a display unit.

In addition, Japanese unexamined patent publication No. 2004-246372 discloses an image forming apparatus in which a cartridge accommodating consumables has a CPU and memory built therein. The CPU writes a cumulative value of the rotation number of a photosensitive drum into the memory. When the cumulative value reaches or exceeds a prescribed value, the image forming apparatus judges the cartridge is run out and displays a warning that the cartridge is no longer available.

As discussed above, the conventional image forming apparatuses with memory built in a toner cartridge can permit the memory to function as a counter and display a manufacturer code to inform of the original manufacturer. On the other hand, the image forming apparatuses with memory built therein can display messages on the display unit based on information stored in the memory, however requires replacing software in the image forming apparatus to change the message contents to be displayed. This causes a problem of lack of adaptability.

### SUMMARY OF THE INVENTION

An object of the present invention is to provide a consumable storage container enabling more effective use of memory and easy change of messages to be displayed, and an image forming apparatus with the consumable storage container inserted therein.

The consumable storage container holding consumables for use with the image forming apparatus according to the present invention includes a memory unit for storing message information depending on operating statuses of the image forming apparatus and an output unit for outputting message information in accordance with a command from the memory unit.

According to the present invention, by storing message information depending on the operating status of the image forming apparatuses into the memory unit built in the consumable storage container and outputting message information depending on the operating status of the image forming apparatus in response to the command from the image forming apparatus it is possible to effectively utilize the memory and offer more useful information to customers.

According to another aspect of the present invention, the image forming apparatus has a consumable storage container, which holds consumables, attached therein. The consumable storage container includes a memory unit for storing message information depending on the operating statuses of the image forming apparatus, a message information setting unit for setting the message information in the memory unit and a read-out unit for detecting the operating status of the image forming apparatus and reading out message information depending on the operating status from the memory unit.

More preferably, the image forming apparatus includes a display unit for displaying the message information read out by the read-out unit.

Specifically, the memory unit stores message information depending on the operating statuses including power-on mode, standby mode and error-detection mode, respectively, of the image forming apparatus.

The memory unit stores display timing information of the image forming apparatus and message information to be displayed at the display timing. The read-out unit detects the display timing of the image forming apparatus to read out the corresponding message information from the memory unit.

### BRIEF DESCRIPTION OF THE DRAWINGS

FIG. 1 is a block diagram of an image forming apparatus in an embodiment of the present invention.

FIG. 2 illustrates the arrangement of an operation unit and display unit of the image forming apparatus.

FIG. 3 illustrates the configuration of memory built in a toner cartridge.

FIG. 4 illustrates display messages displayed with various display timings.

FIG. 5 is a flow chart describing the operation of the embodiment of the present invention.

FIG. 6 is a block diagram showing an information writer.

### DESCRIPTION OF PREFERRED EMBODIMENT

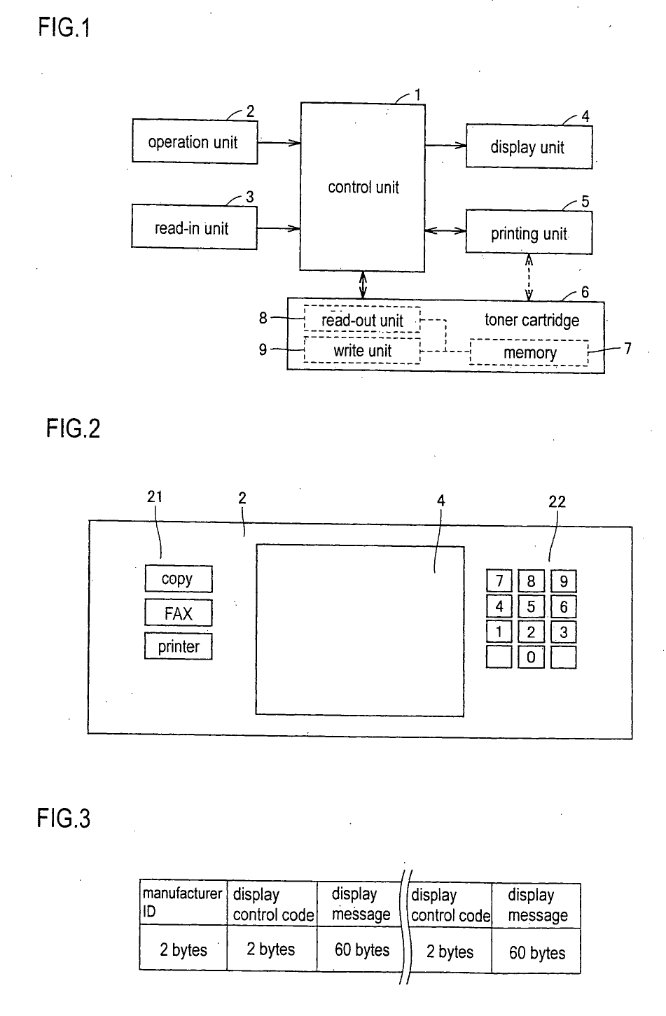

FIG. 1 is a block diagram of an image forming apparatus according to an embodiment of the present invention. FIG. 2 illustrates the arrangement of an operation unit and a display unit of the image forming apparatus. FIG. 3 illustrates the configuration of memory built in a toner cartridge.

The image forming apparatus, shown in FIG. 1, that is a multifunctional printer having functions as a copying machine, FAX machine and printer includes a control unit 1. There are an operation unit 2, a read-in unit 3, a display unit 4 and a printing unit 5 each connected to the control unit 1. The operation unit 2, as shown in FIG. 2, is provided with switching keys 21 to select a function from copying, faxing and printing and a numeric keypad 22. The display unit 4 is a liquid crystal display capable of displaying various types of information and has touch keys 23 arranged on the liquid crystal display, which allow a user to set paper size, print density, etc.

When the image forming apparatus transmits images as a FAX machine or forms images as a copying machine or a scanner, the read-in unit 3 reads original documents. The printing unit 5 prints out data when the image forming apparatus receives the data as a FAX machine or duplicates images as a copying machine. A toner cartridge 6 serving as a consumable storage container is mounted in the printing unit 5. The toner cartridge 6 incorporates memory 7 as a memory unit, a read-out unit 8 as an output unit and a write unit 9. The memory 7 has areas as shown in FIG. 3 and stores a plurality sets of 2 bytes of manufacturer ID, 2 bytes of display control code and 60 bytes of display message.

The manufacturer ID identifies the manufacturer's name of the image forming apparatus. The control unit 1 can read out a display message corresponding to the identified display control code from the memory 7. The control unit 1 examines the contents in the memory 7 when power is turned on or the cover of the read-in unit 3 is opened or closed and then performs display processing for the display unit 4. The read-out unit 8 reads out display message information from the memory 7 in response to a command from the control unit 1. The write unit 9 writes a display message input through the operation unit 2 into the memory 7.

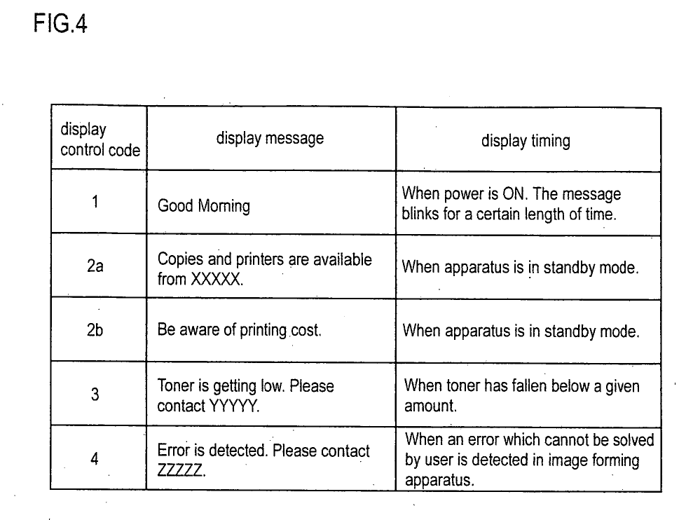

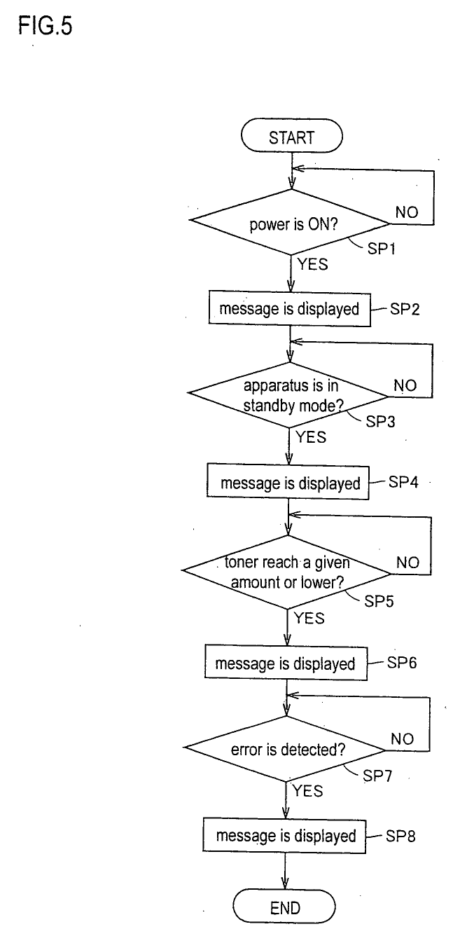

FIG. 4 illustrates display messages to be displayed with the various display timings, while FIG. 5 is a flow chart describing the operation of the embodiment of the present invention. It should be understood that although display messages corresponding to the display timings are stored in FIG. 4, the display messages may be prepared depending on operating statuses of the image forming apparatus.

When the image forming apparatus is turned on at Step (SP for short in drawings) SP1 in FIG. 5, the control unit 1 determines whether the power is on or not. The control unit 1 which had determined the power was turned on judges that it is display timing in power-on mode and then reads out a display message corresponding to the display control code “1” stored in the memory 7 shown in FIG. 4 to display the message on the display unit 4 in Step SP 2. Since many image forming apparatuses are powered on in the morning, the display message may be, for example “Good Morning”, but of course other display messages are available. In addition, this display message may be configured to blink for a certain length of time.

A user chooses one function from faxing, copying and scanning according to his/her need to execute a job. The image forming apparatus that has finished the job enters standby mode. The control unit 1, in Step SP 3, determines whether the image forming apparatus has completed the job as a copying machine and entered the standby mode before executing another job, for example. If the image forming apparatus is not in the standby mode, the control unit 1 waits for the image forming apparatus to enter the standby mode. If the control unit 1 determines that the image forming apparatus is in the standby mode, the control unit 1 judges it is display timing in the standby mode of the apparatus and displays a message corresponding to the display control code “2a” in Step SP 4. This display message may be related to the dealer selling this image forming apparatus and its consumables, for example, “Copiers and printers are available from XXXXX”.

It is also possible in Step SP 4 to display a message corresponding to the display control code “2b”, which is “Be aware of printing cost” as shown in FIG. 4, when the control unit 1 judges it is display timing in the standby mode of the apparatus.

The control unit 1 determines whether the toner is reduced to a given amount or lower in Step SP 5. If it is determined that the toner is reduced to a given amount or lower, the control unit 1 judges that it is display timing in which the remaining toner has fallen below the given amount and displays a message corresponding to the display control code “3”, that is “The toner is getting low. Please, contact YYYYY.” in Step SP 6. In Step SP 7, the control unit 1 determines whether an error which cannot be solved by users has been detected in the image forming apparatus. If the error is detected, the control unit 1 judges that it is display timing in which the unsolvable error is detected in the image forming apparatus and displays a message corresponding to the display control code “4”, that is “Error is detected. Please contact ZZZZZ.” in Step SP 8.

Incidentally, the image forming apparatus may be configured so that the user or dealer operates the operation unit 2 to input their own desired display messages. To do this, the control unit 1 that functions as a message information setting unit feeds the display messages input from the operation unit 2 to the write unit 9 which writes the display messages in the memory 7.

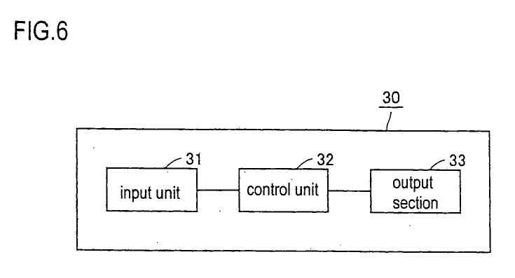

It is also possible to write the display messages in the memory 7 by using an externally provided writing machine. FIG. 6 is a block diagram showing such an information writer. In FIG. 6, the information writer 30 is prepared for the user or dealer to write their own desired display messages in the memory 7 provided on the toner cartridge 6 shown in FIG. 1 in a noncontact manner. The information writer 30 includes an input unit 31, a control unit 32 and an output section 33. The input unit 31 is configured to input the display message information and so forth. The control unit 32 causes the output section 33 to output the input display message information to the write unit 9 of the toner cartridge 6. The output section 33 includes a sending circuit for wirelessly or optically transmitting the display message information. In this example, the write unit 9 shown in FIG. 1 includes a receiving circuit for wirelessly or optically receiving the display message information.

Upon changing the display message, the user or dealer operates the information writer 30 to input their own desired display messages. With the display message, for example a display control code is also input through the input unit 31. The control unit 32 causes the output section 33 to wirelessly or optically send the input display control code and display message. The write unit 9 incorporated in the toner cartridge 6 receives the display control code and display message sent from the information writer 30 and writes them in the memory 7.

Incidentally, the control to write the message information in the memory 7 may be performed with a higher priority than the control to read out the message information which is performed in the image forming apparatus 10.

In addition, the information writer 30 can be configured so as to have a function of checking the written message. Further, the information writer 30 can be configured so as to write the message into the memory 7 through, for example, a cable instead of the noncontact transmission.

Further, it is possible to replace the information writer 30 with a personal computer having a communication facility in order to write the message into the memory 7 through the write unit 9 in the toner cartridge 6 and to check the written message in the noncontact manner.

According to the embodiment discussed above, direct writing of desired display messages in the memory 7 can be achieved by operating the information writer 30. Then, the message stored in the memory 7 can be displayed on the display unit 4 in response to display timing issued by the image forming apparatus. As a result, it is possible to foster better service for users through the sale of consumables such as toner.

Especially, since the display messages help to establish a close relationship between a user and a dealer selling the consumables recommended by the manufacturer of the image forming apparatus, it may prevent other dealers from selling adulterations, which are not manufacture's products. For example, each memory 7 may be configured so as to previously store the dealer's contact information such as a telephone number and display the telephone number.

Even if the dealer changes, the contact information can be readily rewritten into the memory 7, thereby preventing the user from confusing the contact information of the old dealer and the current dealer upon ordering the consumables such as toner, therefore improving service for the user.

Further, at the time of purchase of toner or the like from the dealer, it is possible to display information, for example “10% OFF”.

The description was made on the multifunctional printer, but the present invention is not limited to this. The present invention is also applicable to a descrete device such as a copying machine and FAX machine.

In addition, the message information may be provided as voice information instead of the readable information displayed on the display unit 4.

The foregoing has described the embodiment of the present invention by referring to the drawings. However the invention should not be limited to the illustrated embodiment. It should be appreciated that various modifications and changes can be made to the illustrated embodiment within the scope of the appended claims and their equivalents.

What is claimed is:

1. A consumable storage container holding consumables for use with an image forming apparatus, the consumable storage container comprising:
a memory unit for storing message information depending on the operating status of the image forming apparatus; and
an output unit for outputting the message information depending on the operating status of the image forming apparatus from the memory unit in response to a command from the image forming apparatus.

2. An image forming apparatus with a consumable storage container for holding consumables inserted therein, the image forming apparatus comprising:
a memory unit built in the consumable storage container and for storing message information depending on the operating status of the image forming apparatus; and,
a read-out unit for detecting the operating status of the image forming apparatus and reading out message information depending on the operating status from the memory unit.

3. The image forming apparatus according to claim 2 further comprising a message information setting unit for setting the message information in the memory unit.

4. The image forming apparatus according to claim 2 further comprising a display unit for displaying the message information read out by the read-out unit.

5. The image forming apparatus according to claim 2, wherein
the memory unit stores message information depending on operating statuses including power-on mode, standby mode and error-detection mode, respectively.

6. The image forming apparatus according to claim 2, wherein
the memory unit stores display timing of the image forming apparatus and message information to be displayed at the display timing, and
the read-out unit detects the display timing of the image forming apparatus and reads out the corresponding message information from the memory unit.
